(19) United States
(12) Patent Application Publication
(10) Pub. No.: US 2024/0113380 A1
(43) Pub. Date: Apr. 4, 2024

(54) SAFETY VENT FOR CYLINDRICAL BATTERIES

(71) Applicant: Purdue Research Foundation, West Lafayette, IN (US)

(72) Inventors: Jason Ostanek, West Lafayette, IN (US); Weisi Li, West Lafayette, IN (US)

(73) Assignee: Purdue Research Foundation, West Lafayette, IN (US)

(21) Appl. No.: 18/375,350

(22) Filed: Sep. 29, 2023

Related U.S. Application Data
(60) Provisional application No. 63/411,488, filed on Sep. 29, 2022.

(51) Int. Cl. H01M 50/342; H01M 50/213; H01M 50/30; H01M 50/358; H01M 50/559

(52) U.S. Cl. CPC H01M 50/3425; H01M 50/213; H01M 50/358; H01M 50/394; H01M 50/559; H01M 10/0422

(57) ABSTRACT

A safety vent assembly for a cylindrical battery may include a burst disk configured to open and at least partially define a vent in response to a thermal runaway of the battery. The safety vent assembly may further include a current collector and a positive terminal. A turbulence promoter may be defined on the current collector. Gas from inside the battery may pass through the turbulence promoter and the vent formed by the burst disk during thermal runaway.

### CROSS REFERENCE TO RELATED APPLICATIONS

This application claims the benefit of U.S. Provisional Application No. 63/411,488 filed Sep. 29, 2022, the entirety of which is incorporated by reference herein.

### TECHNICAL FIELD

This disclosure relates to lithium ion batteries and, in particular, to safety designs for lithium ion batteries.

### BACKGROUND

Li-ion batteries have become a popular energy storage device due to their high power and energy density, minimal memory effect, long calendar life, and long cycle life. Furthermore, their cost has decreased in recent years. One of the outstanding challenges, however, is that Li-ion batteries pose a fire risk. When subject to abuse conditions (internal short circuit, external short circuit, mechanical penetration or crush, overcharge, high temperature, etc.), the internal temperature of the battery cell increases. Once the cell temperature increases, a series of chemical reactions begins due to the decomposition of the active materials within the cell. These decomposition reactions produce heat and gas. The excess heat causes the cell temperature to increase even more which accelerates the reaction rate. Unless this excess heat is removed, a positive feedback loop will be established—this is commonly known as thermal runaway. Often, fire and flame occur during thermal runaway. In a battery module or pack, the presence of fire and flame poses a risk to the neighboring cells. If too much heat is transferred from the failed cell to the neighbors, then the neighbors will enter thermal runaway. Cascading, or propagating failure is a catastrophic failure mode where thermal runaway propagates from one cell to the next. This can lead to large scale fires, loss of the equipment or asset, and possibly injury or death.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a qualitative representation of an internal temperature and pressure of a Li-ion cell during thermal runaway—along with instantaneous snapshots of the state of the battery cell.

FIG. 2 illustrates a cross-sectional view of a cylindrical Li-ion cell showing flow path of flammable gases within the cell.

FIG. 3 illustrates an expanded view of a safety vent assembly.

FIG. 4 illustrates a schematic showing two primary modes of heat transfer from flames emerging from a cell in thermal runaway.

FIG. 5 is a schematic illustrating how turbulent mixing reduces the convection heat transfer on nearby surfaces.

FIG. 6 cross sectional view of a safety vent assembly with gas flow paths.

FIG. 7 illustrates a bottom view of a safety vent assembly.

FIG. 8 illustrates a top view of a safety vent assembly.

FIG. 9 illustrates an example of a safety vent assembly with a potwelded current interrupt device.

FIG. 10 illustrates an example of a safety vent assembly having a positive terminal with a turbulence promotor.

FIG. 11 illustrates an example of a battery pack having a dilution hole.

### DETAILED DESCRIPTION

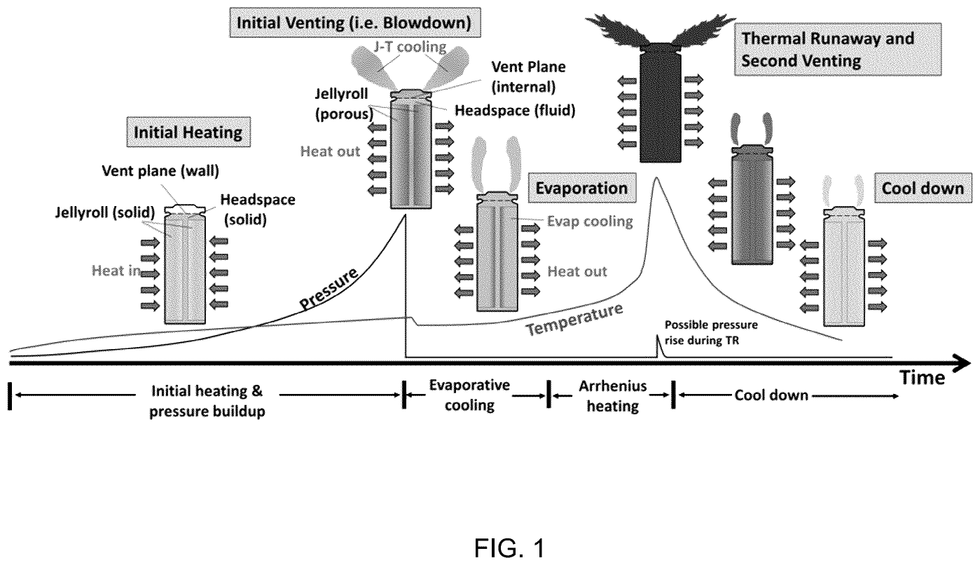

FIG. 1 illustrates a qualitative representation of an internal temperature and pressure of a Li-ion cell during thermal runaway—along with instantaneous snapshots of the state of the battery cell. In this example, the battery is heated by some external source, such as sitting in a hot environment. The cell temperature increases and, simultaneously, the internal pressure increases. At the moment labeled “initial venting”, the built-in pressure relief mechanism opens to allow the gases to escape which corresponds to a sudden decrease of the internal cell pressure. There is a momentary decrease in cell temperature, but heating continues into the “thermal runaway” regime, where fire and flame are usually observed. After thermal runaway, the cell cools down.

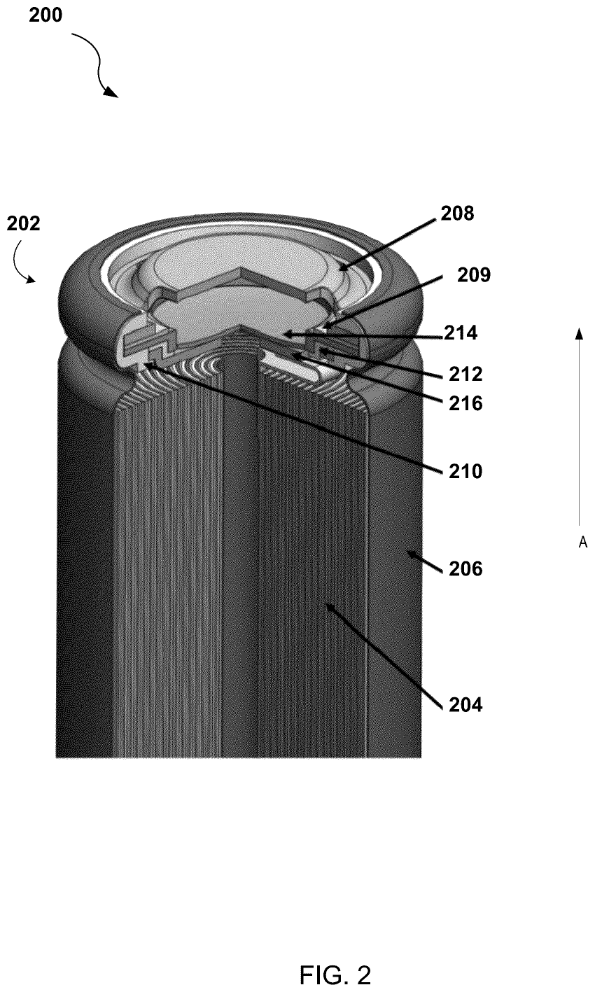

FIG. 2 illustrates a cross-sectional view of a cylindrical Li-ion cell 200 showing flow path of flammable gases within the cell. The Li-ion battery (LIB) cell may include a safety vent assembly 202, electrochemical materials 204, and a casing 206, which may be metallic casing. The electrochemical materials 204 may include the jelly role, which is a combination of the anode, separator, and cathode.

Cylindrical Li-ion battery cells may be constructed such that the active electrochemical materials 204 are contained within the metallic casing 206. During thermal runaway failure, the internal pressure increases—discussed previously and shown in FIG. 1. In order to avoid an energetic rupture of the metallic outer casing 206, sending debris away at high velocity, the safety vent assembly 202 allows the gases to escape the cell. The safety vent assembly 202 may include a positive terminal 208, a PTC Disk 209, an gasket 212, a burst disk 214, and a current collector 216, and an insulation ring 210. When the battery is oriented along an axial direction A such that the positive terminal 208 defines an end of the battery, the positive terminal 208 may be positioned axially outward from the burst disk 214, and the burst disk 214 may be positioned axially outward from the current collector 216.

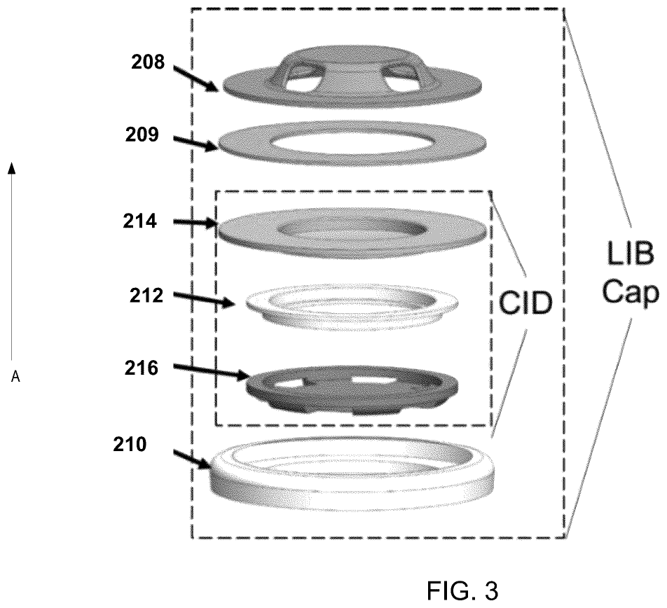

FIG. 3 illustrates an expanded view of a safety vent assembly. The safety vent assembly 202 may include a positive terminal 208, a PTC Disk 209, a insulation ring 210, a gasket 212, a burst disk 214, and a current collector 216.

In some examples, the positive terminal 208 may include a metallic component which has holes or slots machined into it which allow the flow of gases. For example, the safety vent assembly may have 4 holes arranged symmetrically, though other arrangements are possible. The positive terminal typically functions as the positive terminal connection point of the Li-ion cell.

The safety vent assembly may include a PTC device 302. The PTC device slows the flow of electrical current within the cell for protective purposes. As the temperature of the PTC device increases, its electrical resistance increases (hence, it has a positive temperature coefficient of resistance). The increased resistance may slow the flow of electrical current to slow the onset of thermal runaway or prevent it altogether. The PTC device is a temperature-activated safety mechanism. Some battery designs do not use a PTC device.

The burst disk 214 permits gases to escape the battery cell to prevent energetic rupture of the cell casing. The burst disk may include a thin metallic membrane with a circular groove, or score-mark. The groove is a designed failure point. Under normal operating conditions the burst disk 214 is impermeable to the flow of gases. When pressure inside the cell increases, the burst disk 214 breaks at the designed failure point. The burst disk 214 then physically deforms and deflects so that gases can pass through. When the burst disk opens, this is a pressure-activated safety mechanism. We also refer to this as the vent mechanism or pressure relief mechanism.

The gasket 212 may include an electrically insulating material that separates the burst disk 214 from the current collector 216. Another protection mechanism within the safety vent assembly is known as the current interrupt device (CID). Since the safety vent comprises an electrical circuit in series connection, there is an opportunity to slow the current with the PTC device or stop the current with the CID. The CID is pressure-activated. When the internal pressure of the cell becomes too large, a connection between the burst disk and current collector will be broken—this broken connection is the CID mechanism. In order for the CID mechanism to operate properly, the burst disk and current collector may be electrically insulated from one another using the gasket component. The only connection between the burst disk and current collector is a connection at the CID mechanism, usually a spot-welded connection.

The current collector 216 (which may also be referred to as a Tag-Mount Disk) may include a metallic component that serves as the connection point between the positive electrode within the cell (not pictured) to the safety vent assembly. The bottom view of the MTI safety vent assembly actually shows a tag which is used to make the electrical connection to the positive electrode. The current collector may also have holes machined into it, which allow for gases to escape the battery cell.

The insulation ring 210 may form a seal between the safety vent assembly and the outer metallic casing of the battery cell.

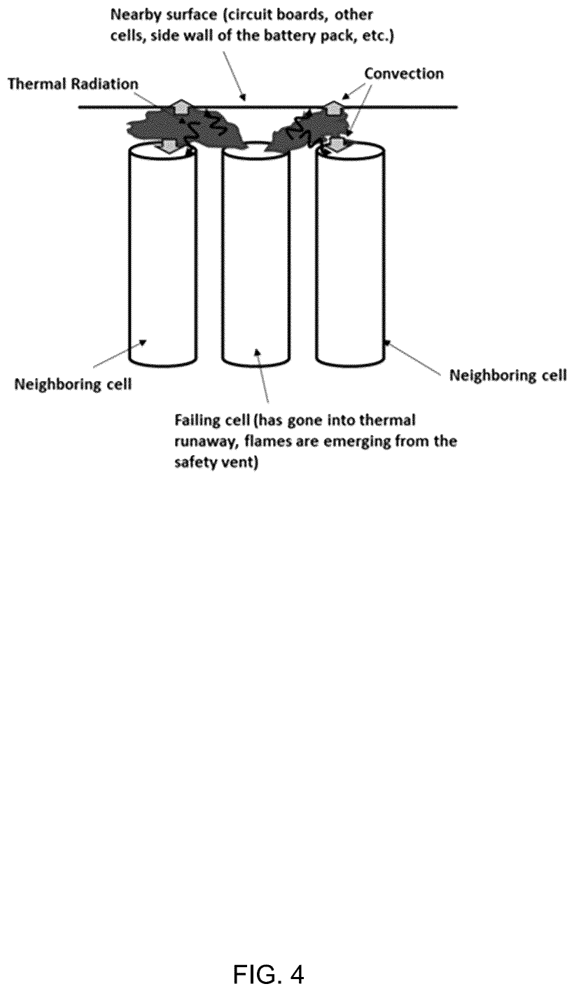

FIG. 4 illustrates a schematic showing two primary modes of heat transfer from the flames emerging from a cell in thermal runaway are convection and thermal radiation

When a battery cell goes into thermal runaway, there is often several flames emerging from the cell. The hot gases and particulates in these flames may transfer heat to nearby cells through two modes of heat transfer: convection and thermal radiation. Convection heat transfer occurs form the physical contact of hot gases with nearby surfaces. Thermal radiation does not require physical contact and occurs from the volumetric emission of electromagnetic energy which is then absorbed by the nearby surfaces.

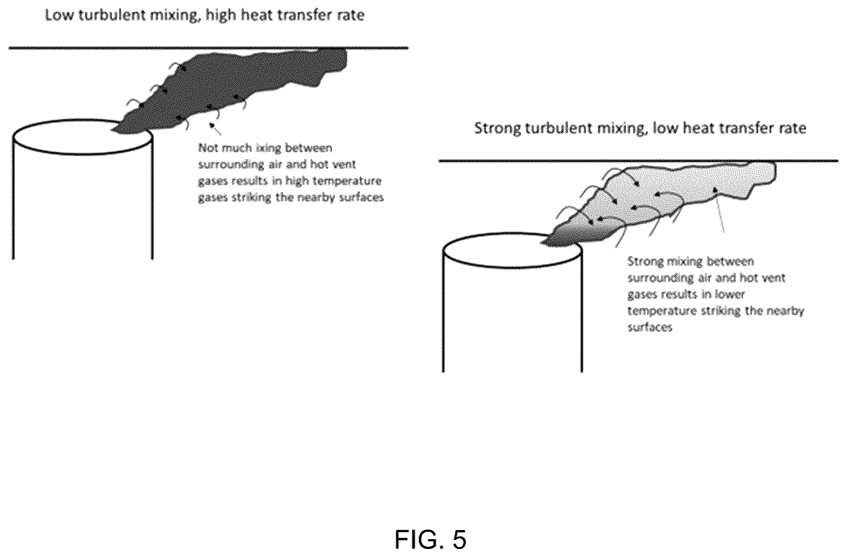

FIG. 5 is a schematic illustrating how turbulent mixing reduces the convection heat transfer on nearby surfaces. To minimize heat transfer on nearby surfaces, the temperature of the gases emerging from the cell must be reduced. This may be accomplished by mixing of the hot gases emerging from the cell with the surrounding, cooler air. A safety vent assembly according to the various examples and embodiments described herein, promotes turbulence and mixing may reduce the heat transfer on nearby surfaces. It should be noted that mixing of surrounding air into the flame region may be providing more oxygen into the combustion reactions, which could have an adverse effect that increases the flame temperature. However, in the very early stages of thermal runaway, oxygen is produced within the battery cell itself—and it will be assumed that the hot gases emerging from the cell have already burned to completion and there is no fuel remaining—therefore, mixing of oxygen into the flame region will not have an adverse effect.

As illustrates in FIG. 5. hot gases are diluted through the mixing process. This results in lower temperature gases striking nearby surfaces. Although not pictured, the turbulent mixing also reduces the thermal radiation heat transfer which decreases with decreased gas temperatures.

Depending on the implementation and use case, various design modifications may be made. If turbulent mixing of vent gases does not lead to additional heat release from combustion, then the vent may be designed to promote turbulent mixing. This will lead to reduced heat transfer rates on nearby surfaces.

If turbulent mixing of vent gases leads to additional heat release from combustion, then the vent may be designed to suppress turbulent mixing. Further more, there may be some optimal design which seeks to minimize the heat release from combustion as well as the heat transfer on nearby surfaces.

Turbulent mixing may be increased by modifying the safety vent to include turbulence promoting features on any of the components which lie in the flow path of the hot gases: current collector, burst disk, or positive terminal.

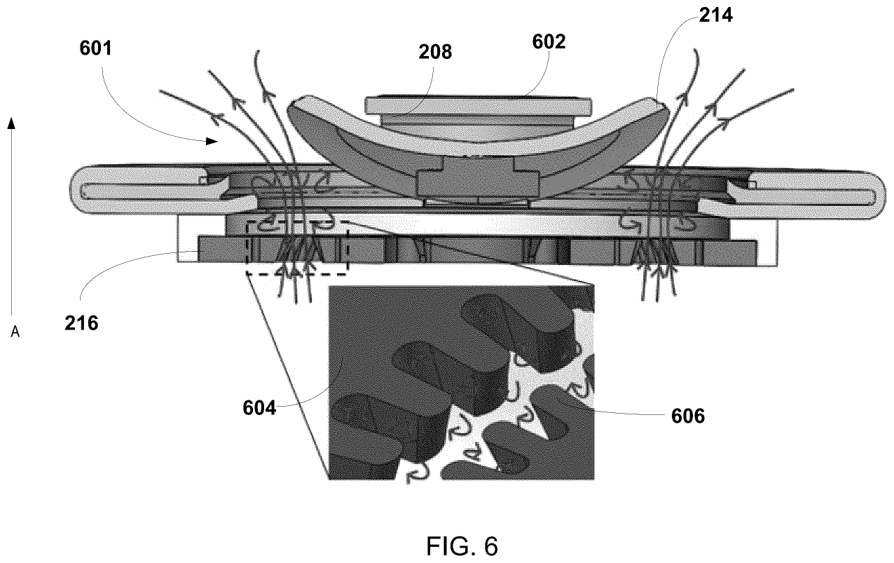

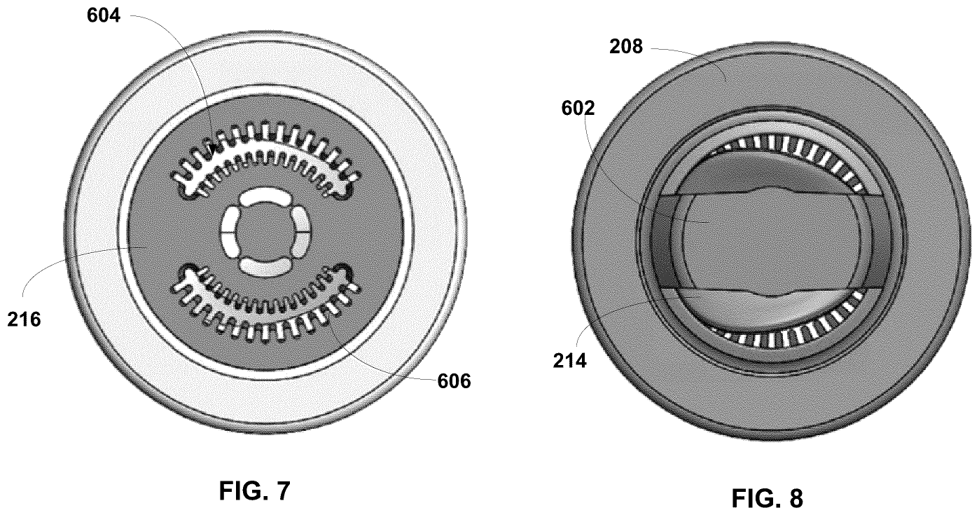

FIGS. 6-8 illustrate an example of a safety vent assembly with a turbulence promotor and unconfined burst disk. FIG. 6 cross sectional view of the safety vent assembly with gas flow paths. FIG. 7 illustrates a bottom view of the safety vent assembly. FIG. 8 illustrates top view of an example of the safety vent assembly.

To enhance the safety of Li-ion safety vent, the design of the safety vent assembly may be improved with at least two targets: (1) the improved safety may have minimum restriction to the gas flow through it; (2) the venting jets emerged from the improved safety vent may have minimum heat transfer to the surrounding surfaces. The first target aimed at making the high pressure gas produced in the thermal runaway reactions to quickly vent out and lowering the pressure inside the cell to avoid cell case rupture. The venting flow usually carries electrolyte vapors and solid particles. Reducing the restriction of the venting flow can avoid the blockage of the opening area by the solid materials. The equivalent area of the safety vent can be used as a parameter to evaluate the restriction of venting flow by the safety vent. The equivalent area of the safety vent is inversely proportional to the flow restriction. To achieve the first goal, the equivalent area of the safety vent should be enlarged. If the first goal can be achieved, the increased mass flowrate of the venting jet will cause the jet impingement heat transfer rate to be higher. The large heat transfer to the surrounding may raise the potential for thermal runaway propagation. Therefore, the second design goal was aimed at lowering the jet impingement heat transfer rate. Nusselt number is an appropriate parameter to evaluate the jet impingement heat transfer rate. The venting jet emerged from the improved Li-ion cell safety vent deign should have minimum Nusselt number on the impinged surface.

In the improved safety vent design, the opening area of the positive terminal component and current collector plate may be enlarged. In addition, the blockage of the positive terminal holes by the broken burst disk may be reduced. In the meantime, the impingement heat transfer of the venting jets may also be lowered. Considering the effect of turbulent mixing on the jet impingement heat transfer analyzed before, turbulence promoters can be added in the current collector plate to produce highly turbulent flow and increase the turbulence mixing. Lobed mixers are used to enhance the turbulent mixing in the exhaust system in turbofan engines and other applications. The lobed mixers can be created on the edge of the holes in the current collector to increase turbulence mixing in the flow.

Accordingly, the burst disk 214 may be configured to open and at least partially define a vent 601 in response to a thermal runaway of the battery. The positive terminal 208 may include a beam 602 that extends across the top end of the positive terminal. For example, the beam 602 may extend across a diameter of the cylindrical battery. The beam 602 may be offset from the burst disk 214 along an axial direction A toward an end of the battery. The burst disk 214 may include a notch groove which does not extend the whole circle, but leaves an arc with, for example, 30 degrees without notch groove as the connection. The non-notched connection may be located below the beam in the positive terminal so that the edge of the center part of the burst disk will wrap around the beam.

The vent assembly may include a turbulence promotor 604 on the current collector 216. In some examples, the turbulence promoter 604 may include a lobe mixer. For example, the lobe mixer may include a hole defined by a plurality of lobes 606. Alternatively or in addition, the turbulence promoters 604 can have protruding surfaces, such as ribs or pins (also know as pin-fins). Sharper edges and/or increasing the surface area of the ventholes may also increase turbulence. The turbulence promoters may be positioned immediately adjacent to the opening formed by the burst disk during activation. Hot gas from inside the battery passes through the turbulence promoter 604 and the vent 601 formed in the burst disk 214 during the thermal runaway.

As illustrates in FIG. 6-8, the current collector center 216 may fixed with the burst disk 214 and connected to the other parts of the current collector with four short notch grooves. After CID-activation, the current collector breaks at the center notch grooves leaving the center of the current collector still attached to the burst disk. A large hole was created on the current collector at center. There were two long slot holes on the current collector. To increase turbulent mixing, lobed mixers were created on the edge of the long slot holes.

When the gas flow passed the current collector slot holes, turbulent structures were generated in the jet. To enlarge opening area of the new design, the two long slot holes in the current collector located right below the two holes in the positive terminal. This arrangement created a more direct path for the venting flow to reduce the restriction to the venting flow.

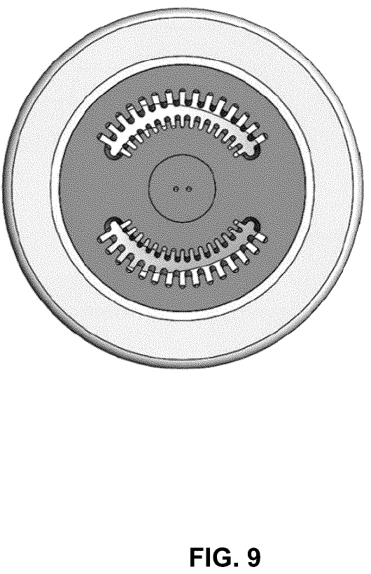

FIG. 9 illustrates an example of a safety vent assembly with potwelding CID. To lower the Nusselt number of the improved safety vent design, the CID may be connected via spot welds in the center of the current collector.

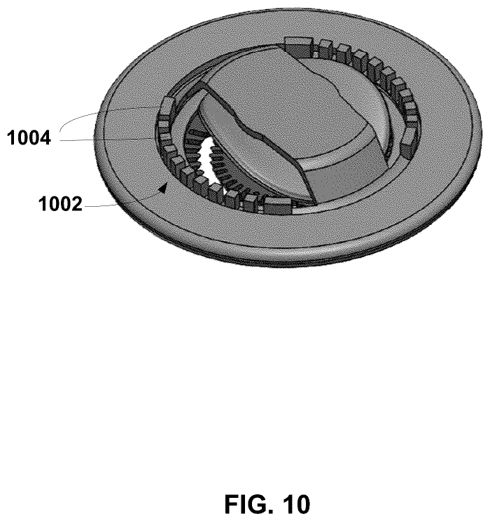

FIG. 10 illustrates an example of a safety vent assembly having a positive terminal with a turbulence promotor 1002. In some examples, the turbulence promoter may include fins 1004, such as square extrusions, which extend radially outward from the beam. The fins can also take on other shapes, as well, depending on the design. Thus, when the burst disk is activated, the extrusions may promote turbulence. In some examples, the fins may extend toward an end of the battery away from a surface of the positive terminal.

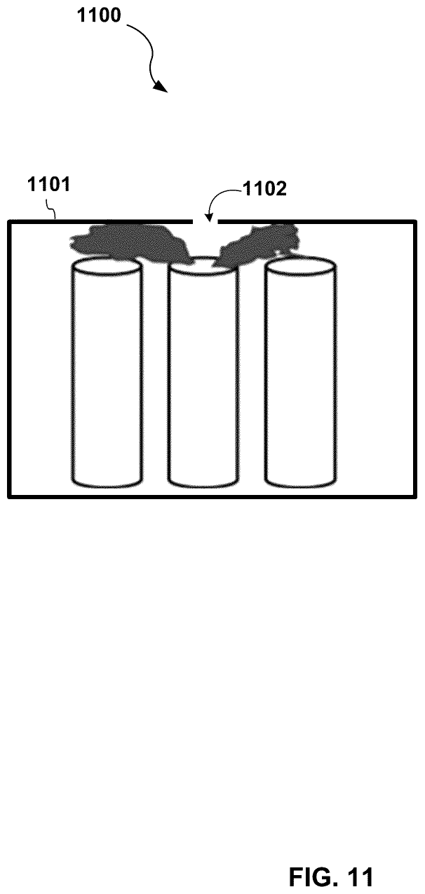

FIG. 11 illustrates an example of a battery pack having a dilution hole 1102. The turbulence promoters may dilute the hot gases venting from the battery cell. The dilution of the hot gases takes place through the turbulent mixing of the hot gases with the surrounding cooler air. In some examples, the battery module or pack may include a casing 1101 that retains the batteries. The casing may have a dilution hole 1102 for dilution air to be introduced. Cool gas from outside the battery passes through the hole 1102 of the casing and dilutes the hot gas released from the safety valve assembly of the battery. The hole 1102 may be positioned on a side of the casing proximate to the safety vent of the battery.

According to some embodiments, the safety vent assembly described herein may allow gases to escape from the battery cell. The cross-sectional flow area may be increased to allow for gases to escape from the cell more easily. The cross-sectional flow area may be increased by enlarging the holes in the current collector or positive terminal assembly. In addition, the safety vent geometry may be tailored to allow the burst disk to deflect out of the way of the escaping gases

While various embodiments have been described, it will be apparent to those of ordinary skill in the art that many more embodiments and implementations are possible. Accordingly, the embodiments described herein are examples, not the only possible embodiments and implementations.

What is claimed is:

1. A safety vent assembly for a cylindrical battery, comprising:
A burst disk configured to open and at least partially define a vent in response to a thermal runaway of the battery;
a current collector; and
a positive terminal,
wherein a turbulence promoter is defined on the current collector,
wherein gas from inside the battery passes through the turbulence promoter and the vent formed by the burst disk during the thermal runaway.

2. The safety vent assembly of claim 1, wherein the turbulence promoter comprises a hole defined by a plurality of lobes.

3. The safety vent assembly of claim 1, wherein the turbulence promotors are positioned adjacent to the vent formed during thermal runaway.

4. The safety vent assembly of claim 1, wherein the positive terminal includes a second turbulence promotor.

5. The safety vent assembly of claim 4, wherein the second turbulence promotor includes a plurality of extrusions defined adjacent to the vent formed during thermal runaway.

6. The safety vent assembly of claim 1, wherein positive terminal includes a beam that extends across a diameter of the safety vent assembly, wherein the burst disk is configured to at least partially bend around the beam in response to the thermal runaway.

7. The safety vent assembly of claim 6, wherein the vent formed during thermal runaway is defined by a bent portion of the burst disk.

8. A cylindrical battery comprising:
a safety valve assembly positioned on the positive end of the terminal, the safety valve assembly comprising:
a burst disk configured to open and at least partially define a vent in response to a thermal runaway of the battery;
a current collector; and
a positive terminal,
wherein a turbulence promoter is defined on the current collector,
wherein gas from inside the battery passes through the turbulence promoter and the vent formed by the burst disk during the thermal runaway.

9. The cylindrical battery of claim 8, wherein the turbulence promoter comprises a hole defined by a plurality of lobes.

10. The cylindrical battery of claim 8, wherein the turbulence promotors are positioned adjacent to the vent formed during thermal runaway.

11. The cylindrical battery of claim 8, wherein the positive terminal includes a second turbulence promotor.

12. The cylindrical battery of claim 11, wherein the second turbulence promotor includes a plurality of extrusions defined adjacent to the vent formed during thermal runaway.

13. The cylindrical battery of claim 8, wherein positive terminal includes a beam that extends across a diameter of the safety vent assembly, wherein the burst disk is configured to at least partially bend around the beam in response to the thermal runaway.

14. The cylindrical battery of claim 8, wherein the vent formed during thermal runaway is defined by a bent portion of the burst disk.

15. A battery pack, comprising:
a cylindrical battery comprising a safety valve assembly positioned on the positive end of the terminal, the safety valve assembly comprising:
a burst disk configured to open and at least partially define a vent in response to a thermal runaway of the cylindrical battery;
a turbulence promoter defined by the a current collector, a positive terminal, or a combination thereof,
wherein hot gas from inside the battery passes through the turbulence promoter and the vent formed in the burst disk during the thermal runaway.

16. The battery pack of claim 15, further comprising:
a casing having the cylindrical battery disposed therein, the casing having a hole,
wherein cool gas from outside the battery passes through the hole of the casing and dilutes the hot gas released from the safety valve assembly of the battery.

17. The battery pack of claim 16, wherein the hole of the casing is positioned on a side of the casing proximate to the safety vent of the battery.
